(19) United States
(12) Patent Application Publication
(10) Pub. No.: US 2009/0103635 A1
(43) Pub. Date: Apr. 23, 2009

(54) SYSTEM AND METHOD OF UNEQUAL ERROR PROTECTION WITH HYBRID ARQ/FEC FOR VIDEO STREAMING OVER WIRELESS LOCAL AREA NETWORKS

(76) Inventor: Peshala Vishvajith Pahalawatta, Urbana, IL (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/874,133

(22) Filed: Oct. 17, 2007

(51) Int. Cl. H04N 11/04

(52) U.S. Cl. 375/240.27; 375/E07.279

(57) ABSTRACT

A transmitter system comprises an interface operative to receive compressed video data for a group of pictures, each picture containing picture subsets; a data prioritization engine operative to define a priority level of each picture subset, the priority level being based on a picture contribution value of the picture subset; and a packet generation engine operative to generate a group of message packets, the group containing at least a portion of the picture subsets belonging to a particular priority level, and operative to generate parity packets corresponding to the group of message packets, the number of parity packets being based on the particular priority level. The transmitter system may further comprise a hybrid ARQ/FEC engine operative to await an ACK in response to communication of the message and parity packets, and operative to send at least one additional parity packet if the ACK is not received within a timeout period.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates generally to wireless local area networks (WLANs), and more particularly provides a system and method for unequal error protection with hybrid ARQ/FEC for video streaming over WLANs.

### BACKGROUND

As users experience the convenience of wireless connectivity, they are demanding increasing support. Typical applications over wireless networks include video streaming, video conferencing, distance learning, etc. Because wireless bandwidth availability is restricted, quality of service (QoS) management is increasingly important in wireless networks.

The IEEE 802.11 standard dominates the market among standards adopted for WLANs. However, because network/channel conditions and other factors affect data transmission over wireless mediums, every data packet does not always reach its destination. Accordingly, protocols are needed to manage failed data transmission.

The existing IEEE 802.11 standard improves the reliability of data transmissions by using a stop-and-wait Automatic Repeat reQuest (ARQ) protocol in which the transmitter retransmits a data packet when it does not receive an acknowledgement (ACK) within a specified timeout period. Similarly, in systems employing the IEEE 802.11e standard, a transmitter can send a block of data packets and await a blockACK response. If no ACK or blockACK is received within the specified timeout period, the transmitter may retransmit the data, up to a predetermined number of times. These schemes lead to high latency and jitter, especially when operating under non-ideal network/channel conditions. Latency and jitter significantly affect the viewing quality of real-time video streaming systems, since a decoder may not receive video packets prior to their respective playback times. Further, each retransmission requires the transmitter to contend for channel access, which causes additional delay.

Prior art reliability enhancement mechanisms include forward error correction (FEC). By introducing redundancy in transmitted data, FEC enables a decoder to correct a predetermined number of data errors from a subset of the received data, without resorting to retransmission. FEC leads to lower variability in packet delays, and therefore, lower jitter. However, FEC leads to increased channel utilization.

Example prior art references include the following:
1. “Wireless LAN Media Access Control (MAC) and Physical Layer (PHY) Specification,” IEEE Standard 802.11, 1999.
2. Q. Li and M. van der Schaar, “Error Protection of Video over Wireless Local Area Networks through Real-Time Retry Limit Adaptation,” Proc. of IEEE Int. Conf. on Acoustics Speech and Signal Processing (ICASSP), Vol. 5, May 2004, pp. V-993-996.
3. M.-H. Lu, P. Steenkiste, and T. Chen, “A Time-Based Adaptive Retry Strategy for Video Streaming in 802.11 WLANs,” Wireless Communications and Mobile Computing, Special Issue on Video Communications for 4G Wireless Systems, vol. 7, no. 2, January 2007, pp. 187-203.
4. A. Albanese, J. Blomer, J. Edmonds, M. Luby, and M. Sudan, “Priority Encoding Transmission,” IEEE Trans. on Information Theory, Vol. 42, No. 6, Part 1, November 1996, pp. 1737-1744.
5. A. Majumdar, D. G. Sachs, I. V. Kozintsev, K. Ramchandran, and M. M. Yeung, “Multicast and Unicast Real-Time Video Streaming Over Wireless LANs,” IEEE Trans. on Circuit and Systems for Video Technology, vol. 12, no. 6, June 2002, pp. 524-534.
6. U.S. Pat. No. 6,289,054
7. U.S. Pat. No. 6,421,387
8. U.S. Pat. No. 6,658,019
9. U.S. Pat. No. 6,789,123
10. U.S. Pat. No. 6,934,752
11. U.S. Pat. No. 6,999,432
12. U.S. Pat. No. 7,095,729
13. U.S. Pat. No. 7,257,664
14. U.S. Pat. No. 6,154,780
15. U.S. Patent Application Publication No. 2004/0123211
16. U.S. Patent Application Publication No. 2007/0209057
17. “Hybrid ARQ for Robust Video Streaming Over Wireless LANs;” IEEE, Proceedings International Conference on Information Technology: Coding and Computing; April 2001; pp. 317-321
18. “Error Control and Concealment for Video Communication: A Review;” Proceedings of the IEEE, Vol. 86, No. 5; May 1998; pp. 974-997
19. “Hybrid Error Control Mechanism for Video Transmission in the Wireless IP Network,” 10^{th} IEEE Workshop on Local and Metropolitan Area Networks; 1999; pp. 126-132
20. “Time-based Adaptive Retry for Wireless Video Streaming,”<http://amp.ecc.cmu.edu/Publication/Amy/WCMC07_TAR_lu.pdf>

### SUMMARY

A system according to one embodiment of the invention employs a scheme that applies FEC unequally depending on the importance of video packets. Video packet importance may be determined by the contribution of a video packet towards improving decoder error concealment and reducing error propagation effects. To manage changing network/channel conditions, a system according to one embodiment may enable dynamic modification of the level of FEC applied to the video packets, e.g., the number of parity packets generated. Further, to limit channel utilization of FEC, a system according to one embodiment may employ a dynamic ARQ/FEC mechanism that enables dynamic adaptation to channel conditions. In one embodiment, the system is implemented at the application (APP) layer. In another embodiment, the system is implemented at the medium access control (MAC) layer (with appropriate modifications to the existing IEEE 802.11 MAC scheme). Other embodiments may be implemented at different layers or across layers.

The system may lead to less jitter by avoiding multiple retransmissions, decreasing channel utilization, improving recovery from packet losses at the video decoder due to prioritization of more important video packets, and increasing visual quality of the streamed video content.

In accordance with an embodiment, the present invention provides a transmitter system comprising an interface operative to receive compressed video data for a group of pictures, each picture containing picture subsets; a data prioritization engine operative to define a priority level of each picture subset, the priority level being based on a picture contribution value of the picture subset; and a packet generation engine operative to generate a group of message packets, the group containing at least a portion of the picture subsets belonging to a particular priority level, and operative to generate a number of parity packets corresponding to the group of message packets, the number of parity packets being based on the particular priority level.

For the transmitter system, the picture subsets may include slices, each slice may contain a plurality of macroblocks, and the priority level of a slice may be based on the picture contribution value of the macroblocks contained therein. The priority level of a slice may be based on the following MPEG-based scheme:
Priority Level 1: I picture slices;
Priority Level 2: P picture slices containing more than a first proportion of I MBs;
Priority Level 3: B picture slices containing more than a second proportion I MBs;
Priority Class 4: All other slices containing less than a third proportion of Skip MBs.
Priority Class 5: All other slices containing more than a fourth proportion of Skip MBs.
   The number of parity packets corresponding to the particular priority level may be dynamically modified based on the channel or network conditions. The transmitter system may further comprise a communication engine for communicating the group of message packets and the number of parity packets over a lossy communication medium; and a hybrid ARQ/FEC engine operative to await an ACK in response to the communication of the group of message packets and the number of parity packets, and operative to send a block of at least one additional parity packet if the ACK is not received within a first timeout period. The hybrid ARQ/FEC engine may repeat the sending of the block of at least one additional parity packet until either an ACK is received or a second timeout period has expired. The picture contribution value may include its value towards improving decoder error concealment and reducing error propagation effects. The packet generation engine may packetize all pictures subsets of the particular priority level into the group of message packets.

In accordance with an embodiment, the present invention provides a transmitter method comprising receiving compressed video data for a group of pictures, each picture containing picture subsets; defining a priority level of each picture subsets the priority level being based on a picture contribution value of the picture subset; generating a group of message packets, the group containing at least a portion of the picture subsets belonging to a particular priority level; and generating a number of parity packets corresponding to the group of message packets, the number of parity packets being based on the particular priority level.

For the transmitter method, the picture subsets may include slices, each slice may contain a plurality of macroblocks, and the defining of a priority level of a slice may be based on the picture contribution value of the macroblocks contained therein. The priority level of a slice may be based on the following MPEG-based scheme:
Priority Level 1: I picture slices;
Priority Level 2: P picture slices containing more than a first proportion of I MBs;
Priority Level 3: B picture slices containing more than a second proportion I MBs;
Priority Class 4: All other slices containing less than a third proportion of Skip MBs.
Priority Class 5: All other slices containing more than a fourth proportion of Skip MBs.
   The transmitter method may further comprise dynamically modifying the number of parity packets corresponding to the particular priority level based on the channel or network conditions. The transmitter method may further comprise communicating the group of message packets and the number of parity packets over a lossy communication medium; awaiting an ACK in response to the communication of the group of message packets and the number of parity packets; and sending a block of at least one additional parity packet if the ACK is not received within a first timeout period. The transmitter method may further comprise repeating the sending of the block of at least one additional parity packet until either an ACK is received or a second timeout period has expired. The picture contribution value may include its value towards improving decoder error concealment and reducing error propagation effects. The generating the group of message packets may include packetizing all pictures subsets of the particular priority level.

In accordance with an embodiment, the present invention provides a receiver system comprising a lossy communication medium; a communication engine operative to receive header information specifying a predetermined number of message packets, message packets and parity packets from the lossy communication medium, the message packets containing picture subsets corresponding to a particular priority class, the number of parity packets being based on the particular priority class; and an FEC management engine operative to determine whether a sufficient number of message or parity packets has been received to recreate the predetermined number of message packets.

For the receiver system, the picture subsets may include slices, each slice may contain a plurality of macroblocks, and the priority level of a slice may be based on the picture contribution value of the macroblocks contained therein. The receiver system may further comprise an ACK generation engine operative to generate an ACK when the sufficient number of message and parity packets has been received.

In accordance with an embodiment, the present invention provides a receiver method comprising receiving header information specifying a predetermined number of message packets, message packets and parity packets from a lossy communication medium, the message packets containing picture subsets corresponding to a particular priority class, the number of parity packets being based on the particular priority class; and determining whether a sufficient number of message or parity packets has been received to recreate the predetermined number of message packets.

For the receiver method, the picture subsets may include slices, each slice may contain a plurality of macroblocks, and the priority level of a slice may be based on the picture contribution value of the macroblocks contained therein. The receiver method may further comprise generating an ACK when the sufficient number of message and parity packets has been received.

### BRIEF DESCRIPTION OF THE DRAWINGS

FIG. 1 is a block diagram of a wireless local area network, in accordance with an embodiment of the present invention.

FIG. 2 is a block diagram of a transmitter system, in accordance with an embodiment of the present invention.

FIG. 3 is a block diagram of an unequal error protection transmit engine, in accordance with an embodiment of the present invention.

FIG. 4 is a block diagram of a receiver system, in accordance with an embodiment of the present invention.

FIG. 5 is a block diagram of an unequal error protection receive engine, in accordance with an embodiment of the present invention.

FIG. 6(a) is a block diagram of a typical group of packet structure of compressed pictures of a video sequence.

FIG. 6(b) is a block diagram of a typical RTP packet.

FIG. 6(c) is a block diagram of a typical RTP-based video-specific header.

FIG. 7 is a block diagram of the priorities of slices of compressed pictures of video sequence, in accordance with an embodiment of the present invention.

FIG. 8(a) is a block diagram of original video packets.

FIG. 8(b) is a block diagram of the message packet stream, in accordance with an embodiment of the present invention.

FIG. 8(c) is a block diagram of the parity packet stream, in accordance with an embodiment of the present invention.

FIG. 9(a) is a block diagram of the FEC header, in accordance with an embodiment of the present invention.

FIG. 9(b) is a block diagram of the priority class header, in accordance with an embodiment of the present invention.

FIG. 10 is a flowchart of a method of decoding a data packet, in accordance with an embodiment of the present invention.

FIG. 11 is a flowchart of a method of transmitting a data packet, in accordance with an embodiment of the present invention.

### DETAILED DESCRIPTION

The following description is provided to enable any person skilled in the art to make and use the invention and is provided in the context of a particular application. Various modifications to the embodiments are possible, and the generic principles defined herein may be applied to these and other embodiments and applications without departing from the spirit and scope of the invention. Thus, the invention is not intended to be limited to the embodiments and applications shown, but is to be accorded the widest scope consistent with the principles, features and teachings disclosed herein.

A system according to one embodiment of the invention employs a scheme that applies FEC unequally depending on the importance of video packets. Video packet importance may be determined by the contribution of a video packet towards improving decoder error concealment and reducing error propagation effects. To manage changing network/channel conditions, a system according to one embodiment may enable dynamic modification of the level of FEC applied to the video packets, e.g., the number of parity packets generated. Further, to limit channel utilization of FEC, a system according to one embodiment may employ a dynamic ARQ/FEC mechanism that enables dynamic adaptation to channel conditions. In one embodiment, the system is implemented at the application (APP) layer. In another embodiment, the system is implemented at the medium access control (MAC) layer (with appropriate modifications to the existing IEEE 802.11 MAC scheme). Other embodiments may be implemented at different layers or across layers.

The system may lead to less jitter by avoiding multiple retransmissions, decreasing channel utilization, improving recovery from packet losses at the video decoder due to prioritization of more important video packets, and increasing visual quality of the streamed video content.

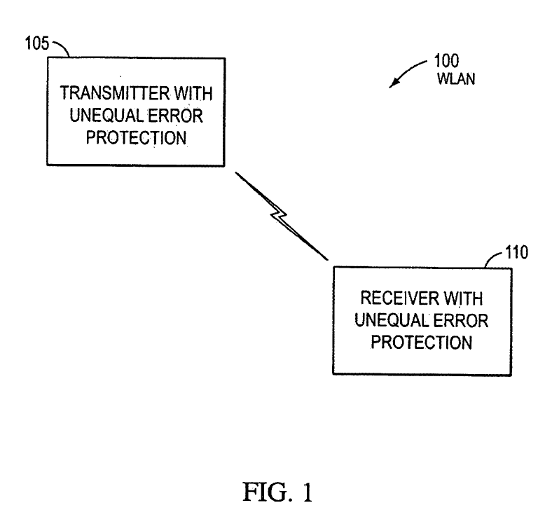

FIG. 1 is a block diagram of a wireless local area network (WLAN) 100, in accordance with an embodiment of the present invention. The WLAN 100 includes a transmitter 105 that employs unequal error protection coupled over a lossy communication medium, e.g., a wireless medium to a receive 110 that employs unequal error protection.

Generally, the transmitter 105 determines the importance of compressed video packets. In existing video compression embodiments implementing standards such as MPEG-2, H.263, and H.264/MPEG-4/AVC, video pictures are fragmented into independently decodable slices. Each slice can contain multiple macroblocks (MBs), which may depend on neighboring MBs within the slice for predictive coding of transform coefficients and motion vector (MV) data, etc. MBs across slices are not interdependent, thus enabling the independent decoding of separate slices. In one embodiment, the transmitter 105 gathers MB type information from the MBs of each slice to determine the importance of the slice. For example, the transmitter 105 treats slices containing mostly Intra-coded (I) MBs as more important, since image degradations caused by the loss of I MBs are more difficult to conceal at the receive 110.

The transmitter 105 provides unequal recovery protection to video packets based on type of video data contained therein. In one embodiment, the FEC scheme consists of an erasure resilient code, e.g., a maximum distance separable (MDS) code such as a Reed Solomon code. An MDS code can be represented using two parameters (m, k), where m denotes the number of message symbols to be encoded and k denotes the number of parity symbols to be added for error protection. MDS codes are characterized by the property that the original m symbols can be recovered if the decoder receives any m of the m+k transmitted message and parity symbols. Therefore, the receiver 110 can tolerate up to k packet losses. In turn, by assigning different values of k relative to channel conditions and/or packet priority levels, the transmitter 105 can vary the level of protection applied to each packet.

In another embodiment, the transmitter 105 may also perform hybrid ARQ/FEC in combination with the unequal error protection scheme described above. The transmitter 105 may dynamically adapt to varying, channel/network conditions, thereby reducing channel utilization compared to a conventional FEC or ARQ scheme. For example, after the initial message and parity packets are transmitted, the transmitter 105 may wait for a specified first timeout period. If an ACK is received within the specified first timeout period, the next block of message and parity packets may be transmitted. Otherwise, the transmitter 105 may send one or more additional parity packets for the current block of message packets until an ACK is received, until a specified second timeout period has expired, until a predetermined number of additional parity packets have been sent, and/or the like. Unlike existing ARQ schemes of IEEE 802.11, in some embodiments, the amount of waiting time and the number of retransmissions may depend on delay deadlines of the video packets to be transmitted.

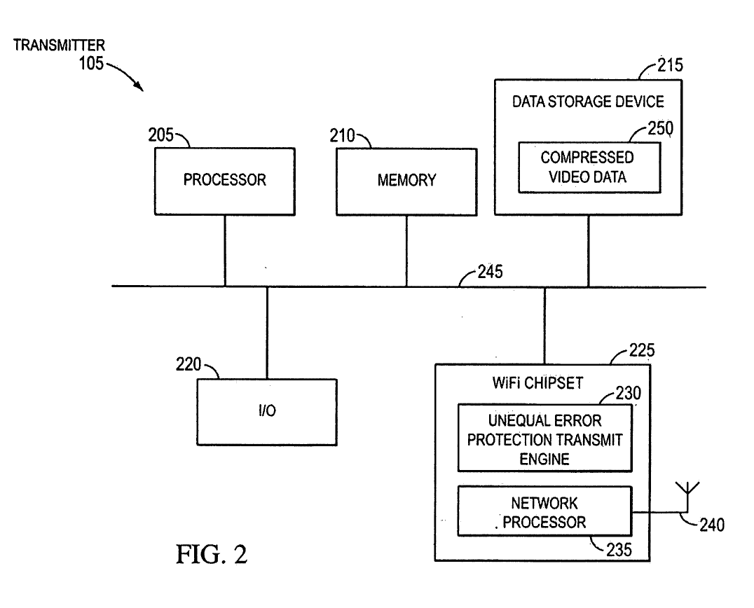

FIG. 2 is a block diagram of a transmitter 105, in accordance with an embodiment of the present invention. The transmitter 105 includes a processor 205 (such as an Intel Pentium® microprocessor or a Motorola Power PC® microprocessor), memory 210 (such as random-access memory), a data storage device 215 (such as a magnetic disk), input/output (I/O) 220 (such as a keyboard, mouse and LCD display), and a WiFi chipset 225, each coupled to the communication channel 245. One skilled in the art will recognize that, although the memory 210 and the data storage device 215 are illustrated as different units, the memory 210 and the data storage device 215 can be parts of the same unit, distributed units, virtual memory, etc. The term “memory” herein is intended to cover all data storage media whether permanent or temporary.

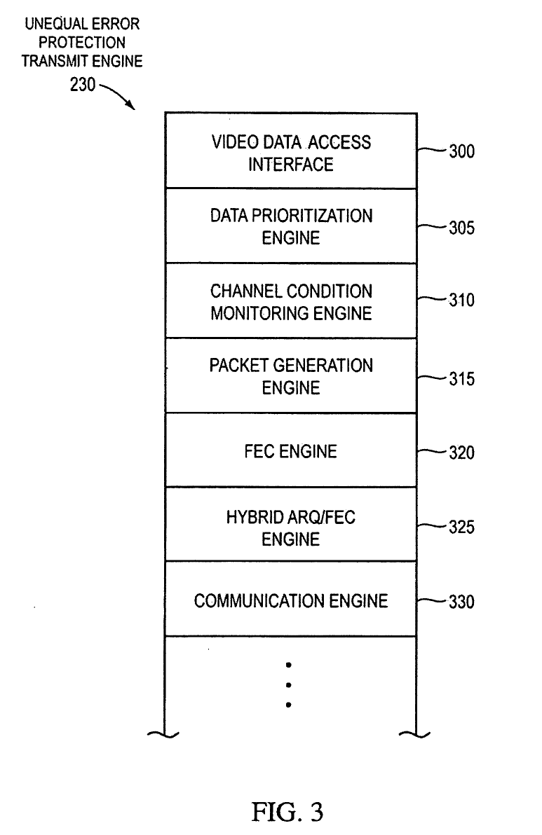

The data storage device 215 stores compressed video data 250 for transmission to the receiver 110. The compressed video data 250 may include data compressed via a block-based hybrid motion compensated compression scheme, e.g., to include I, P and B pictures. In one embodiment, the transmitter 105 receives the compressed video data 250 via an Internet connection (not shown) or via a video encoder (not shown). The WiFi chipset 225 contains an unequal error protection transmit engine 230 and a network processor 235 coupled to a wireless antenna 240. Details of the unequal error protection transmit engine 230 are described below with reference to FIG. 3.

FIG. 3 is a block diagram of an unequal error protection transmit engine 230, in accordance with an embodiment of the present invention. Transmit engine 230 includes a video data access interface 300, a data prioritization engine 305, a channel condition monitoring engine 310, an FEC engine 320, a packet generation engine 315, a hybrid ARQ/FEC engine 325, and a communication engine 330.

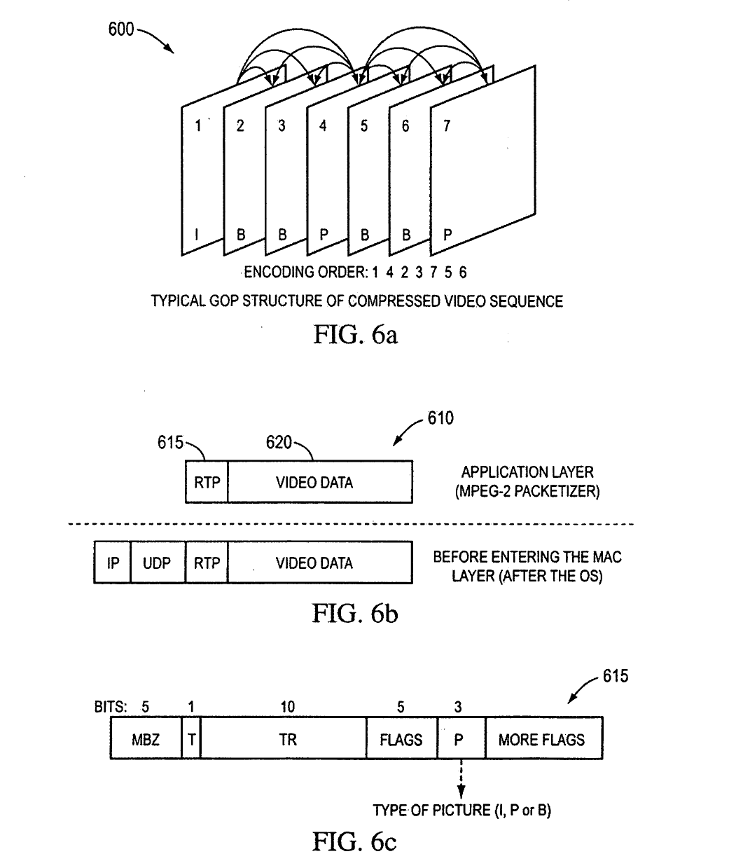

The video data access interface 300 includes hardware, software and/or firmware to enable receipt of the compressed video data stream, e.g., as a stream of data packets containing multiple groups of pictures (GOP). An example GOP 600 is shown in FIG. 6(a). The arrows indicate the directions in which temporal predictions occur. In each GOP, I pictures are not encoded using temporal prediction, P pictures are predicatively coded based on previous I or P pictures, and B pictures are predicatively coded based on the previous and future I or P pictures. A GOP is typically transmitted in order that an I picture or a P picture that follows a B picture is transmitted ahead of the B picture, since the B picture refers to the previous and following I or P pictures. As shown, the encoding order is 1, 4, 2, 3, 7, 5, 6, etc.

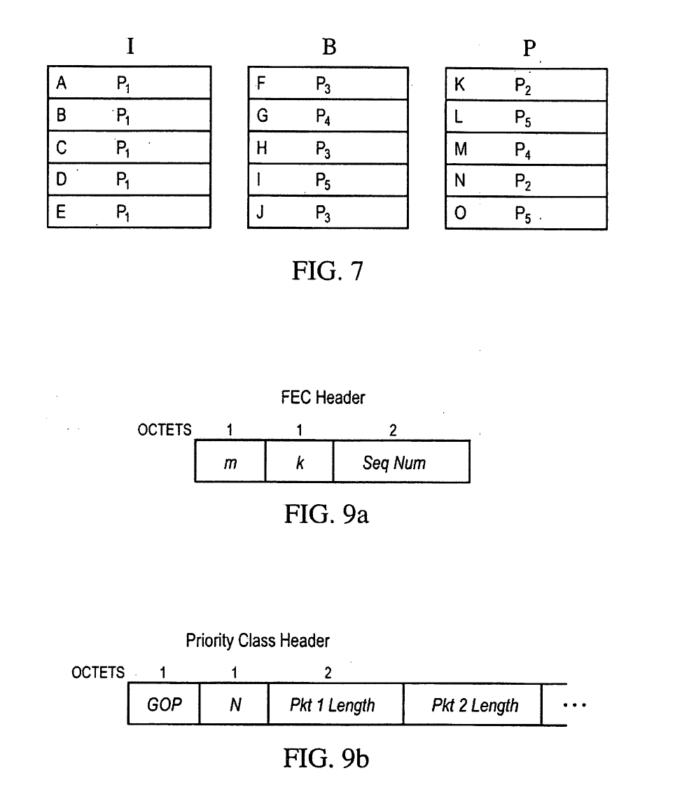

Temporal prediction occurs within each 16×16 block of pixels (commonly referred to as a MacroBlock or MB) in each picture. Each picture is subdivided into slices (see FIG. 7), each containing a groups of MBs. Also, while MBs within each slice are predicatively coded to increase compression efficiency, MBs across slices do not depend on each other, enabling each slice to be independently decodable. I pictures can only contain I MBs (i.e., MBs that are not temporally predicted from previous pictures). P and B pictures can also contain I MBs within them, depending on the particular rate distortion optimization performed during the video encoding. For example, if a scene change occurs at a P picture, a majority of MBs within the picture may be encoded as I MBs. If a MB has little or no change, then a Skip MB can be inserted.

In one embodiment, the stream of data packets include RTP packets. FIG. 6(b) illustrates an example RTP packet 610, which includes an RTP header 615 and a portion 620 of the compressed video data 250, e.g., a plurality of MBs. FIG. 6(c) illustrates and example RTP header 615, which contains a set of fields including a 10-byte temporal reference (TR) field and a 3-byte type of picture (P) field. In one embodiment, for easier prioritization determination at a slice-based level, header information in the stream of RTP packets define the beginning and ending of each picture and the beginning and ending of each slice. Effectively, each slice includes a slice header that contains a resynchronization marker to enable the receiver 110 to recover from the loss of a previous data packet or slice. In one embodiment, each data packet includes the MBs of a slice of a picture.

The data prioritization engine 305 includes hardware, software and/or firmware to prioritize the data packets, e.g., the RTP packets. In one embodiment, the data packet prioritization scheme 305 relies on the fact that a compressed video sequence is composed of multiple groups of pictures (GOPs), each picture composed of multiple slices, each slice composed of multiple MBs, each MB of a particular type, e.g., I, P, B or Skip.

In one embodiment, the data prioritization engine 205 considers two attributes to determine priority class. The first attribute is the difficulty of concealing losses. For example, losses caused by Skip MBs are simpler to conceal, since they occur in low or predictable motion regions of the image. I MBs, when they occur in P and B pictures, generally occur in high and non-predictable motion regions of the image. Therefore, I MBs are less likely concealable if lost. The second attribute is the likelihood of losses leading to further error propagation in temporally dependent pictures. For example, losses in I pictures can propagate to both P and B pictures throughout a GOP, while losses in P pictures can propagate to other P and B pictures. Further, since B pictures are not used as references, losses in B pictures will not propagate to other pictures.

Accordingly, the data prioritization engine 205 reviews the MBs corresponding to a particular slice, and prioritizes the particular slice based on picture and MB characteristics. In one embodiment, the data prioritization engine 205 employs the following priority class assignments:
Priority Class 1: I picture slices
Priority Class 2: P picture slices containing a proportion of more than α I MBs.
Priority Class 3: B picture slices containing a proportion of more than α (or another proportion) I MBs.
Priority Class 4: All other slices containing less than a proportion of β Skip MBs.
Priority Class 5: Slices containing more than a proportion of β (or another proportion) Skip MBs.

The values of α and β (0<α, β<1) can be chosen based on the characteristics of the video content. In one embodiment, these values may be obtained empirically by analyzing the decoded video quality after lossy transmission under varying values of each parameter.

In one embodiment, the data prioritization engine 205 may examine the MB data, e.g., in the case of P and B pictures, to determine data types contained therein. In another embodiment, a cross-layer approach can be used in which the MB type information is provided by the application layer as metadata in the slice, e.g., a 3-bit priority class header. Accordingly, the data prioritization engine 205 may simply review the MB type information in the header to determine priority class. In another embodiment, the priority class may be provided in a slice header, so that no analysis is needed.

An example prioritization is shown in FIG. 7. As shown, each of the I, B and P pictures is divided into five (5) slices. Namely, the I picture is divided into A, B, C, D and E slices; the B picture is divided into the F, G, I and J slices; and the P picture is divided into the K, L, M, N and O slices. In accordance with the above-identified prioritization scheme, all slices of an I picture, namely, slices A, B, C, D and E, are assigned to priority class 1. Based on the number of I MBs and skip MBs in each slice of the B picture, slices F, H and J are assigned to priority class 3, slice G is assigned to priority class 4, and slice I is assigned to priority class 5. Similarly, based on the number of I MBs and skip MBs in each slice of the P picture, slices K and N are assigned to priority class 2, slice M is assigned to priority class 4, and slices L and O are assigned to priority class 5.

The channel condition monitoring engine 310 includes hardware, software and/or firmware to monitor the network and/or channel conditions, e.g., for packet error rates signal strength, signal-to-noise ratio, etc. The channel condition monitoring engine 310 transmits its findings to the packet generation engine 315.

The packet generation engine 315 includes hardware, software and/or firmware to generate a set of priority-encoded data packets from the compressed video data 250.

In one embodiment, the packet generation engine 315 divides the slices of the pictures of a GOP based on priority class. That is, the packet generation engine 315 gathers the slices assigned to priority class 1 into a first group of slices, the slices assigned to priority class 2 into a second group of slices, the slices assigned to priority class 3 into a third group of slices, the slices assigned to priority class 4 into a fourth group of slices, and the slices assigned to priority class 5 into a fifth group of slices. As shown in the example of FIG. 7, slices A, B, C, D and E are the first group of slices; slices K and N are the second group of slices; slices F, H and J are the third group of slices; slices G and M are the fourth group of slices; and slices I, L and O are the fifth group of slices.

The patent generation engine 320 packetizes the slices of the first group of slices (of priority class 1) into a first set of message packets, each with a payload size of predetermined length L. The packet generation engine 315 further generates a first priority class header packet that assists with the decoding of the first set of message packets. The packet generation engine 315 further generates a first group of parity packets, the number of parity packets defined by the priority class.

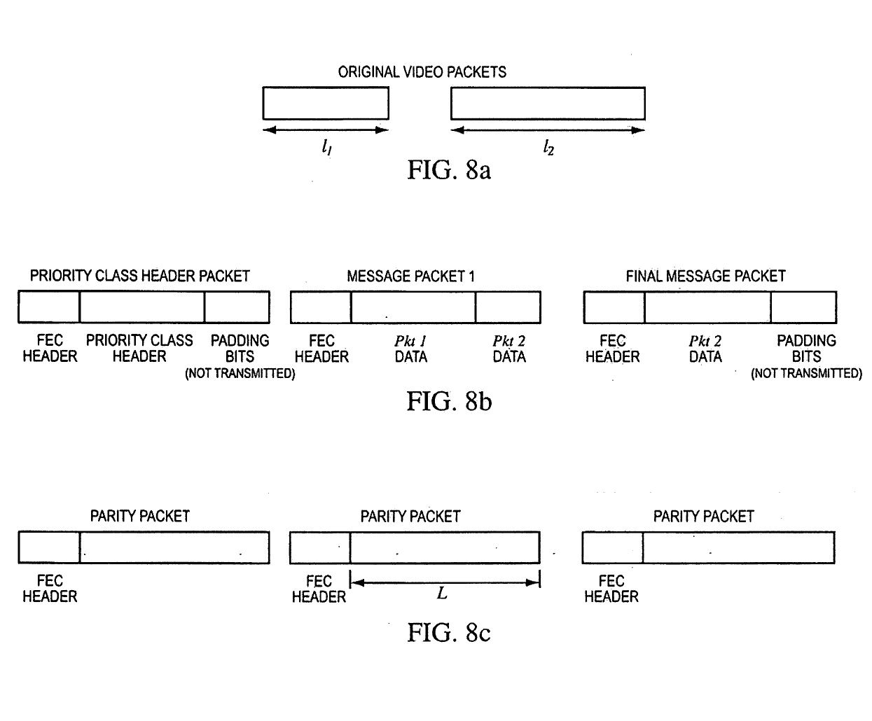

FIG. 8(a) illustrates an example group of slices, e.g., the second group of slices containing slices K an N. As shown, the group of slices includes two slices, namely, a first slice of length l1 and a second slice of length l2. FIG. 8(b) illustrates the group of message packets, each having a payload of length L. The payload of the first message packet includes the first slice and a portion of the second slice. The payload of the second message packet includes the remainder of the second slice and some padding bits (which need not be transmitted). In one embodiment, the packet generation engine 315 packetizes each slice into one priority-encoded data packet and supplies a sequence number for each data packet. FIG. 8(b) illustrates the priority class header packet. FIG. 8(c) illustrates the first group of parity packets, each having a payload of length L. In the example shown, there are three parity packets. However, one skilled in the art will recognize that any number of parity packets may be used.

The predetermined length of a message or parity payload (excluding the FEC header), L, may be computed as follows:

$$L = ⌈ \frac{{\sum }_{s} {l}_{s}}{Num\_Msg \_Pkts} ⌉ ,$$

where Num_Msg_Pkts is fixed for each priority class and each original video packet, s, in a given priority class is of length lₛ. For the example in FIG. 8, Num_Msg_Pkts would be 2. Fixing the number of message packets enables faster implementation of error correction codes, since the same generator matrix can be used for each set of packets. Note that the final message packet may not be completely filled due to round-off errors. In that case, the missing symbols are padded with zeros, as shown in the final message packet in FIG. 8(b), to ensure that packet size remains the same for the parity calculation.

The parity level (k), e.g., the number of parity packets to follow the set of message packets, is computed as follows:

k=┌ρ·(Num_Msg_Pkts+1)┐.

ρ(i) is the priority function for each priority class i. For example, ρ(1) may be 0.5, while ρ(2) may be 0.3. Note that Num_Msg_Pkts+1 is used since an additional class header packet, as shown in FIG. 8(b), will be transmitted with error protection with each block of message packets. The packet length information can be used to parse the individual video packets at the receiver 110, aid to enable reordering the video packets back to their original bitstream order.

The number of parity packets, and thereby, the protection given to each priority class, may be a tunable parameter that depends on the network/channel conditions. The transmitter can dynamically adapt to network/channel conditions by periodically obtaining parameters such as packet error rate from the receivers. Since each receiver can determine the number of message packets and parity packets in a priority class block, as well as the sequence numbers of received packets, each receiver can measure the gaps in the sequence number in the FEC headers of the received packets. For example, when the network/channel condition is poor, ρ(1) may be 0.5. When the network/channel condition is medium, ρ(1) may be 0.4. Further, when the network/channel condition is good, ρ(1) may be 0.3.

The packet generation engine 315 generates an FEC header for each priority-encoded data packet, including for the priority class header packet, the message packets, and the parity packets. FIG. 9(a) illustrates an example FEC header, which as shown includes 1 byte identifying the number (m) of message packets (e.g., Num_Msg_Pkts+1), 1 byte identifying the number (k) of parity packets, and 2 bytes identifying the sequence number Seq Num of the incoming priority-encoded packet. In one embodiment, the sequence number Seq Num is incremented for each message and parity packet of the priority class. At the beginning of each priority class, Seq Num is set to the nearest multiple of 256 greater than its current value. This enables the receiver to determine when a new priority class is being received. The FEC header need not be encoded using the error correction code.

Further, as noted above, the packet generation engine 315 generates a priority class header packet for each set of priority-encoded data packets for a particular priority class. FIG. 9(b) illustrates an example priority class header packet, which includes 1 byte identifying the GOP (incremented at the beginning of each GOP), 1 byte identifying the number (N) of slices or MBs of the priority class, following by N 2-byte fields identifying the length of each slice or MBs in the group of slices. Note that the size of the priority class header packet is not fixed and depends on the number of slices or MBs in the priority class. It is reasonable to expect that its size of the priority class header packet will be smaller than that of a message packet. Additional padding bits may be added to the priority class header packet as necessary so that its length is the same as that of a message packet and to enable the application of FEC to the packet. These padding bits may be removed from the packet prior to transmission.

The FEC engine 320 includes hardware, software and/or firmware to generate parity packets, at the request of the packet generation engine 315.

The hybrid ARQ/FEC engine 325 includes hardware, software and/or firmware to enable dynamic adaptation to network/channel conditions. In one embodiment, the hybrid ARQ/FEC engine 325 may await an ACK response from the receiver. If not received within a specified first time period, the hybrid ARQ/FEC engine 325 may communicate with the FEC engine 320 to generate an additional parity packet, which is forwarded to the receiver 110. This process may be repeated until a specified second timeout period expires, until a predetermined number of additional parity packets have been sent, until an ACK is received, and/or the like. It will be appreciated that, since the highest priority packets are transmitted first, the hybrid ARQ/FEC engine 325 ensures that the most important packets in the GOP will have a greater likelihood of being transmitted on time.

The communication engine 330 includes hardware, software and/or firmware to enable communication of the priority-encoded data packets to the receiver 110. It will be appreciated that the communication engine 330 may strip padding bits, which need not be transmitted.

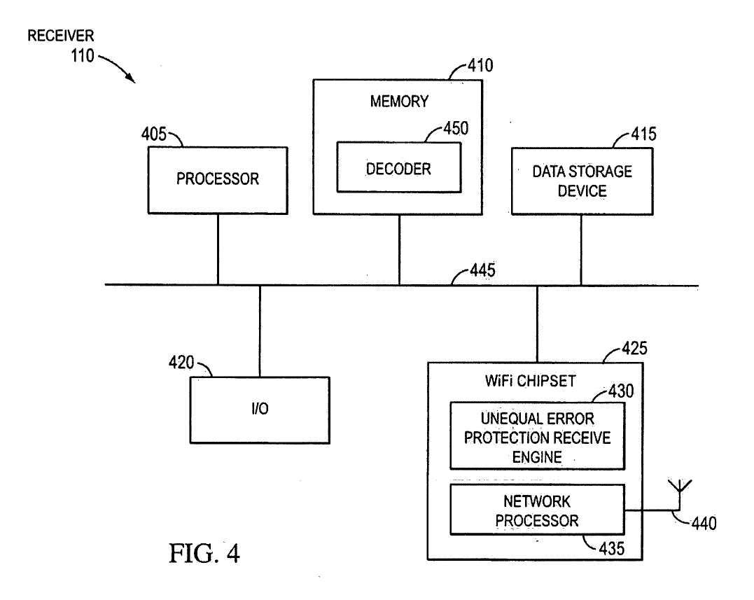

FIG. 4 is a block diagram of a receiver 110, in accordance with all embodiment of the present invention. The receiver 110 includes a processor 405 (such as an Intel Pentium® microprocessor or a Motorola Power PC® microprocessor), memory 410 (such as random-access memory), a data storage device 415 (such as a magnetic disk), input/output (I/O) 420 (such as a keyboard, mouse and LCD display), and a WiFi chipset 425, each coupled to the communication channel 445. One skilled in the art will recognize that, although the memory 410 and the data storage device 415 are illustrated as different units, the memory 410 and the data storage device 415 can be parts of the same unit, distributed units, virtual memory, etc. The term “memory” herein is intended to cover all data storage media whether permanent or temporary.

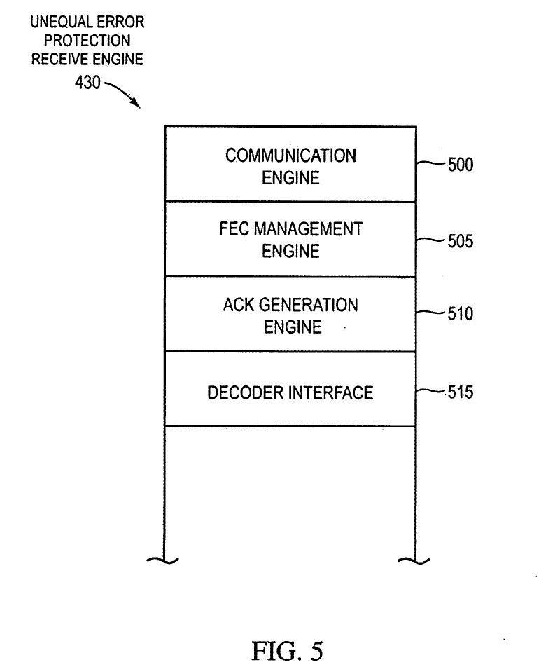

The WiFi chipset 425 contains an unequal error protection receive engine 430 and a network processor 435 coupled to a wireless antenna 440. Details of the unequal error protection receive engine 430 are described below with reference to FIG. 5. Memory 410 stores a decoder 450 that receives the video data from the WiFi chipset 425 and decodes the video data for playback.

FIG. 5 is a block diagram of an unequal error protection receive engine 430, in accordance with an embodiment of the present invention. Unequal error protection engine 430 includes a communication engine 500, an FEC management engine 505, an ACK generation engine 510, and a decoder interface 515.

The communication engine 500 includes hardware, software and/or firmware to receive the priority-encoded data packets from the transmitter 105.

The FEC management engine 505 includes hardware, software and/or firmware to confirm receipt of at least m data packets (message or parity packets) corresponding to the priority class. If the FEC management engine 505 receives at least m data packets, then the FEC management engine 505 instructs the ACK generation engine 510 to send an ACK to the transmitter 105. Otherwise, if the FEC management engine 505 receives fewer than m data packets, then the FEC management engine 505 does not instruct the ACK generation engine 510 to send an ACK to the transmitter 105. If the transmitter 105 is configured to apply a hybrid ARQ/FEC scheme, then the failure to send an ACK will cause the transmitter 105 to send another a series of parity packets. It at any time the FEC management engine 505 receives enough additional parity packets to retrieve the m data packets, then the FEC management engine 505 instructs the ACK generations engine 510 to send an ACK. If an insufficient number of additional parity packets is received, then the FEC management engine 505 instructs the decoder interface 515 to inform the decoder 450 to perform available error recovery processes such as temporal block estimation.

If at least m message or parity packets have been received, then the FEC management engine 505 extracts the video packets from the m message packets.

The ACK generation engine 510 includes hardware, software and/or firmware to generate and initiate the sending of ACKs or blockACKs via the communication engine 500 to the transmitter 105.

The decoder interface 515 includes hardware, software and/or firmware to send the video packets, e.g., RTP packets, to the decoder 450 for playback.

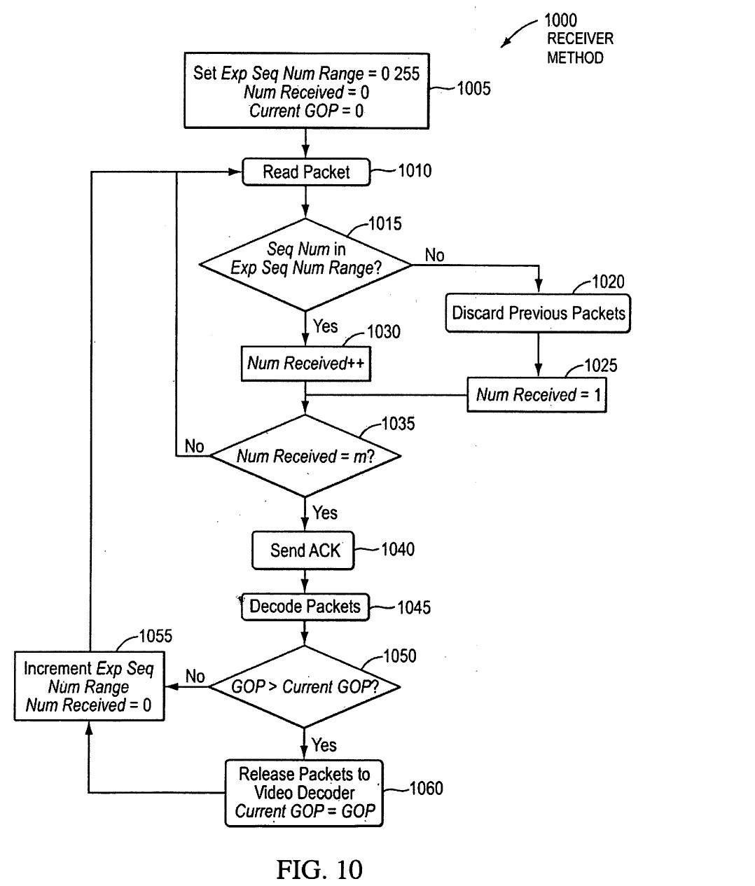

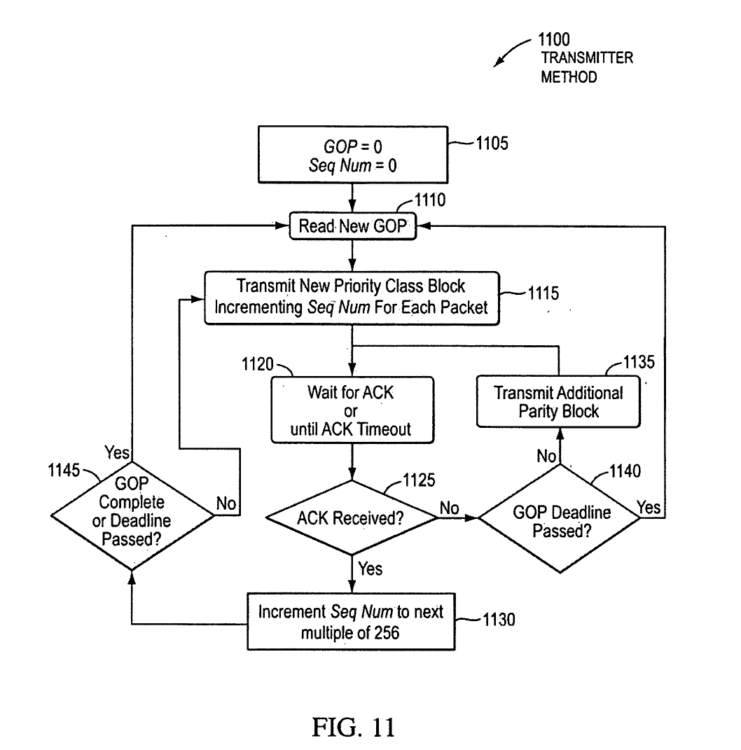

FIG. 10 is a flowchart of a receiver method 1000 of decoding a priority-encoded data packet, in accordance with an embodiment of the present invention. The receiver method 1000 essentially performs the inverse operations of the transmitter method.

The receiver method 1000 begins in step 1005 by setting the sequence number range to be between 0 and 255, setting the packet number received to zero, and setting the current GOP number to zero. In step 1010, the packet is read. In step 1015, the sequence number in the header is compared with the sequence range. If the sequence number is in the range, then in step 1030 the packet number received in increased by one and method 1000 proceeds to step 1035. If the sequence number is not in the range, then in step) 1020 the previous packets are discarded, in step 1025 the number received is set to one, and method 1000 proceeds to step 1035.

In step 1035, the packet number received is compared to m. If the packet number received is not equal to m, then the method 1000 returns to step 1010. If the number received is equal to m, then in step 1040 an ACK is sent. In step 1045, the packets are decoded. In step 1050, if the GOP number is not greater than the current GOP, the in step 1055 the sequence number range is increased to the next increment of 256 and the packet number received is returned to zero. If the GOP number is greater than the current GOP, then in step 1060 the packets are released to the video decoder and the current GOP is set to equal the GOP. Method then proceeds to step 1055.

In one embodiment, the method 1000 operates as follows:
(1) Read FEC header from each received packet, and add packet to appropriate queue by using the sequence number to determine which priority class the packet belongs to.
(2) If sufficient packets are received for decoding (e.g., Num_Msg_Pkts+1), then transmit ACK and invoke the decoding process.
(3) Decode the transmitted priority class FEC header and message packets. Then, use the class header to determine the length in symbols of each video packet contained in the message packets. De-interleave and re-packetize the video packets to generate the video stream.
(4) If the receiver detects that not all necessary packets of the priority class have been received prior to the start of the next priority class, then discard the queued packets from the current class since they cannot be correctly decoded.

FIG. 11 is a flowchart of a transmitter method 1100 of transmitting a data packet using a hybrid ARQ/FEC mechanism, in accordance with an embodiment of the present invention. Method 1100 begins in step 1105 by setting the GOP to zero and the sequence number to zero. In step 1110, a new GOP is read. In step 1115, a new priority class block is transmitted and the sequence number is incremented for each packet. In step 1120, the transmitter waits for an ACK or until an ACK timeout period expires. In step 1125, it is determined whether an ACK has been received. If received, then the method 1000 proceeds to step 1130. If not received, then the method 1000 proceeds to step 1140. In step 1130, the sequence number is incremented to the next multiple of 256. In step 1145, the transmitter determines whether the GOP has completed or the deadline has passed. If either is true, then the method 1000 returns to step 1110. If both are not true, then method 1000 returns to step 1115. In step 1140, the transmitter determines whether the GOP deadline has expired. If expired, then method 1000 returns to step 1110. If it has not expired, then in step 1135 an additional parity block is sent. Method 1000 returns to step 1120 to wait for an ACK.

In one embodiment, the transmit method 1100 operates as follows: The transmitter transmits an initial set of message and parity packets based on the packet priorities, and then waits for an ACK from the receiver. Note that the ACK in this case refers to the application layer acknowledgement, and not the ACK as implemented in the IEEE 802.11 MAC protocol. If an ACK is not received within an ACKTimeout time, then an additional block of parity packets is transmitted. The process repeats until the delay deadline for the packets in the GOP is exceeded, or the number of parity packets assigned to the priority class is exceeded. The delay deadline for the GOP can be calculated using the DTS (Decoding Time Stamp) or PTS (Presentation Time Stamp) present in the MPEG headers of packets in the GOP.

It will be appreciated that unequal error protection described herein can be applied in multicast/broadcast applications. In such applications, it is often difficult to obtain immediate feedback from receivers unless the applications are designed as multiple unicast streams. Multiple unicast streams, however, lead to significantly higher channel utilization. The unequal error protection scheme described herein can be used to reduce channel utilization for multicast applications, while maintaining good quality of video service. In one embodiment, the systems and method described above may be used to stream multiple High Definition video streams over WLANs.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A transmitter system comprising:
an interface operative to receive compressed video data for a group of pictures, each picture containing picture subsets;
a data prioritization engine operative to define a priority level of each picture subset, the priority level being based on a picture contribution value of the picture subset; and
a packet generation engine operative to generate a group of message packets, the group containing at least a portion of the picture subsets belonging to a particular priority level, and operative to generate a number of parity packets corresponding to the group of message packets, the number of parity packets being based on the particular priority level.

2. The transmitter system of claim 1, wherein
the picture subsets includes slices,
each slice contains a plurality of macroblocks, and
the priority level of a slice is based on the picture contribution value of the macroblocks contained therein.

3. The transmitter system of claim 2, wherein the priority level of a slice is based on the following MPEG-based scheme:
Priority Level 1: I picture slices;
Priority Level 2: P picture slices containing more than a first proportion of I MBs;
Priority Level 3: B picture slices containing more than a second proportion I MBs;
Priority Class 4: All other slices containing less than a third proportion of Skip MBs.
Priority Class 5: All other slices containing more than a fourth proportion of Skip MBs.

4. The transmitter system of claim 1, wherein the number of parity packets corresponding to the particular priority level is dynamically modified based on the channel or network conditions.

5. The transmitter system of claim 1, further comprising
a communication engine for communicating the group of message packets and the number of parity packets over a lossy communication medium; and
a hybrid ARQ/FEC engine operative to await an ACK in response to the communication of the group of message packets and the number of parity packets, and operative to send a block of at least one additional parity packet if the ACK is not received within a first timeout period.

6. The transmitter system of claim 5, wherein the hybrid ARQ/FEC engine repeats the sending of the block of at least one additional parity packet until either an ACK is received or a second timeout period has expired.

7. The transmitter system of claim 1, wherein the picture contribution value includes its value towards improving decoder error concealment and reducing error propagation effects.

8. The transmitter system of claim 1, wherein the packet generation engine packetizes all pictures subsets of the particular priority level into the group of message packets.

9. A transmitter method comprising:
receiving compressed video data for a group of pictures, each picture containing picture subsets;
defining a priority level of each picture subset, the priority level being based on a picture contribution value of the picture subset;
generating a group of message packets, the group containing at least a portion of the picture subsets belonging to a particular priority level; and
generating a number of parity packets corresponding to the group of message packets, the number of parity packets being based on the particular priority level.

10. The transmitter method of claim 9, wherein
the picture subsets includes slices,
each slice contains a plurality of macroblocks, and
the defining of a priority level of a slice is based on the picture contribution value of the macroblocks contained therein.

11. The transmitter method of claim 10, wherein the priority level of a slice is based on the following scheme:
Priority Level 1: I picture slices;
Priority Level 2: P picture slices containing more than a first proportion of I MBs;
Priority Level 3: B picture slices containing more than a second proportion I MBs;
Priority Class 4: All other slices containing less than a third proportion of Skip MBs.
Priority Class 5: All other slices containing more than a fourth proportion of Skip MBs.

12. The transmitter method of claim 9, further comprising dynamically modifying the number of parity packets corresponding to the particular priority level based on the channel or network conditions.

13. The transmitter method of claim 9, further comprising
communicating the group of message packets and the number of parity packets over a lossy communication medium;
awaiting an ACK in response to the communication of the group of message packets and the number of parity packets; and
sending a block of at least one additional parity packet if the ACK is not received within a first timeout period.

14. The transmitter method of claim 13, further comprising repeating the sending of the block of at least one additional parity packet until either an ACK is received or a second timeout period has expired.

15. The transmitter method of claim 9, wherein the picture contribution value includes its value towards improving decoder error concealment and reducing error propagation effects.

16. The transmitter method of claim 9, wherein the generating the group of message packets includes packetizing all pictures subsets of the particular priority level.

17. A receiver system comprising:
a lossy communication medium;
a communication engine operative to receive header information specifying a predetermined number of message packets, message packets and parity packets from the lossy communication medium, the message packets containing picture subsets corresponding to a particular priority class, the number of parity packets being based on the particular priority class; and
an FEC management engine operative to determine whether a sufficient number of message or parity packets has been received to recreate the predetermined number of message packets.

18. The receiver system of claim 17, wherein
the picture subsets includes slices,
each slice contains a plurality of macroblocks, and
the priority level of a slice is based on the picture contribution value of the macroblocks contained therein.

19. The receiver system of claim 17, further comprising
an ACK generation engine operative to generate an ACK when the sufficient number of message and parity packets has been received.

20. A receiver method comprising:
receiving header information specifying a predetermined number of messsage packets, message packets and parity packets from a lossy communication medium, the message packets containing picture subsets corresponding to a particular priority class, the number of parity packets being based on the particular priority class; and
determining whether a sufficient number of message or parity packets has been received to recreate the predetermined number of message packets.

21. The receiver method of claim 20, wherein
the picture subsets includes slices,
each slice contains a plurality of macroblocks, and
the priority level of a slice is based on the picture contribution value of the macroblocks contained therein.

22. The receiver method of claim 20, further comprising generating all ACK when the sufficient number of message and parity packets has been received.
